(19) United States
(12) Patent Application Publication
(10) Pub. No.: US 2004/0056953 A1
(43) Pub. Date: Mar. 25, 2004

(54) System and method for controlling service delivery

(76) Inventors: John Christopher Crandall, Fort Collins, CO (US); Carla Amanda Pasetti, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/252,870

(22) Filed: Sep. 20, 2002

(51) Int. Cl. H04N 7/18

(52) U.S. Cl. 348/143

(57) ABSTRACT

An enterprise system for controlling the delivery of services. The system includes a recorder operable for making records of physical objects presented to the recorder, each record including information pertaining to certain potential users, a storage medium for retaining records made by the recorder, and a plurality of terminals dispersed about the enterprise. The terminals are operable when temporarily assigned to an individual for allowing the assigned individual to view certain retained records by entering specified information pertaining to the desired records at the assigned terminal, and the system only allows terminals to access records that are available to the individual to whom the terminal is assigned.

### CROSS-REFERENCE TO RELATED APPLICATIONS

The present application is related to commonly assigned U.S. patent application Ser. No. ______ [Attorney Docket No. 10018883-1] entitled “SYSTEM AND METHOD FOR CAPTURING IMAGES BASED UPON SUBJECT ORIENTATION,” U.S. patent application Ser. No. ______ [Attorney Docket No. 10018884-1] entitled “SYSTEM AND METHOD FOR MONITORING WITHIN A VEHICLE,” and U.S. patent application Ser. No. ______ [Attorney Docket No. 10018886-1] entitled “SYSTEM AND METHOD FOR WIRELESS VIEWING RESTRICTED DATA,” filed on the same date herewith, the disclosures of which are hereby incorporated by reference in their entireties.

### BACKGROUND

Some enterprises, such as hospitals, have many people moving in and out of their facilities every day. A large percentage of these people have documents (including their own images) recorded in a data base and, from time to time, desire to view, copy, and/or send to third parties selected ones of these documents.

Under current systems, this is difficult and time consuming to accomplish. In a typical situation the person who desires to obtain an image (or a copy) must go to a central location and order the image. In any such system, several problems are presented. One such problem is the identification of the document. A second problem pertains to security of the document in that often only certain people are allowed, by government regulation or otherwise, to obtain some images.

When the requesting person is confined to a specific location, such as a hospital room, the procedure for obtaining copies of imaged data becomes difficult, if not impossible. In such a hospital setting, the images could be insurance identification, lists of medications, medical records and the like. The images also could be of new-born babies, or patients.

Pictures of new-born babies are particularly important since parents wish to see their babies as soon as possible and on schedules that do not always coincide with the normal working procedure of the hospital. These pictures can be still pictures taken at random times or can be video images. Using the concepts discussed in the referenced copending applications, the images can be taken from the baby's perspective or of the babies face, regardless of the baby's orientation. Also using the concepts of the referenced copending applications, the images can be taken only when certain movements and/or noises are detected. In any event, the parents may wish to view, and/or print, some or all of the images as soon as possible.

### SUMMARY

Embodiments of the present invention provide an enterprise system for controlling the delivery of services comprising a recorder operable for making records of physical objects presented to the recorder, each record including information pertaining to certain potential users, a storage medium for retaining images of records made by the recorder, and a plurality of terminals dispersed about the enterprise. The terminals are operable when temporarily assigned to an individual for allowing the assigned individual to view certain retained records by entering specified information pertaining to the desired records at the assigned terminal. The system only allows terminals to access records that are available to the individual to whom the terminal is assigned.

Additionally, embodiments of the present invention provide a method of allowing parents to view their children in a hospital setting comprising capturing images of the children, storing the images, receiving a request from a parent pertaining to images the parent desires to view, screening the request for proper identification for the desired image, and providing, under control of the screening process, the desired image to a TV monitor associated with the requesting parent.

Further embodiments provide a system for providing visual monitoring of selected hospital patients comprising a device for capturing images of certain of the patients, a storage device for storing thereon for periods of time captured ones of the images, and a processor for accepting from potential viewers an identification of a desired image to be viewed. Wherein the processor is operable for comparing requests from the potential viewers against an identification of allowed viewers for a particular desired image to be viewed, and is further operable upon a positive comparison from a particular potential viewer for transmitting the desired image to a terminal pre-assigned to the potential viewer.

### BRIEF DESCRIPTION OF THE DRAWINGS

FIG. 1 is a block diagram of one embodiment in accordance with the teachings of the invention;

FIG. 2 is a block diagram of one embodiment of a capture method in accordance with the teachings of the invention;

FIG. 3 is a flowchart of one embodiment of a processing method for controlling image presentation to a requesting viewer in accordance with the teachings of the invention;

FIG. 4 is a flowchart of one embodiment of a processing method for controlling the requesting of images from a viewer in accordance with the teachings of the invention; and

FIG. 5 is a flowchart of one embodiment of a processing method for controlling the disposition of selected images in accordance with the teachings of the invention.

### DETAILED DESCRIPTION

The present embodiments of the invention are directed to a system and method which stores images received from various sources in a data base, each such stored image having associated with it an identity of which allows users to access the image based on the identity of the user.

In one embodiment, the images are accessed via a screen, such as a TV screen, remote from the image storage location. From that remote location the user may view, select, print, email selected ones of the images. The degree to which the user can make copies or otherwise dispose of a particular image is dependant upon the nature of the image. The system could be set so that only people “related” to an image, such as a relative or identified friend, of a patient (in the case of a new-born) or related to a parent, could view the image of the new-born or via the image of the patient. In this context the word related would include certain identified people, by family affiliation and by specific identity or by any affinity grouping, such as co-workers, police, etc.

FIG. 1 is a block diagram of one embodiment in accordance with the teachings of the invention and shows system 10 which includes image capture device 11 for capturing images of various documents. In this regard, documents include paper documents, but also include credit card information, information contained on insurance cards, medical record cards, medical records, digital images of faces, fingerprints and other such information. The image captured by device 11, which could be a camera, card reader, scanner, etc. is sent via connection 101 to processor 12 which may accept a digital image or convert accepted images into a suitable format, such as digital, for further processing according to the present invention. Processor 12 may add identification of the person to which an image belongs. Processor 12 could, if desired, add a code to each image to control the level of availability of the image. The information is then communicated over connection 102 to network 13.

Any of the connections, such as connections 101, 102, 103, 104, 105, 106, 107, 108 and 109 could be any suitable connection, eg. a link comprising a direct connection, a wireless connection or the like.

Network 13 then distributes the image data to various different locations. For example, using connection 104, the information can be sent to billing system 15 or other storage systems which could be either on site or off site. In addition, the captured image data could go to a medical insurance provider, perhaps using an Internet connection (not shown). The information, depending on its nature, could be posted on a web site.

Additionally, or alternatively, network 13 could send the information, via connection 103, to printer 14 which could be in a patient's room, at a central location on the floor, or in another facility.

In operation, by using remote control 17, a prospective viewer inputs into the remote control the user's identification. This identification could be a magnetic stripe on a card, a barcode, or other source of unique data, or it could be fingerprint, eyeprint, or other biometric data. The viewer's information would typically contain the user's name and other information pertaining to the user as shown at 18. Remote control 17 would also have the ability to receive from the user information pertaining to which document, or set of documents, is desired. For example, this input could be by keypad or, if desired, could be by verbal communication.

The information which is obtained from the user from remote control 17 is communicated via connection 106 and process 18 to the network via connection 107, which then provides the desired image or images back to TV viewer 16 or other devices.

Remote 17 can communicate TV 16 or directly to processor 12, if desired, via links 108, 109 respectively.

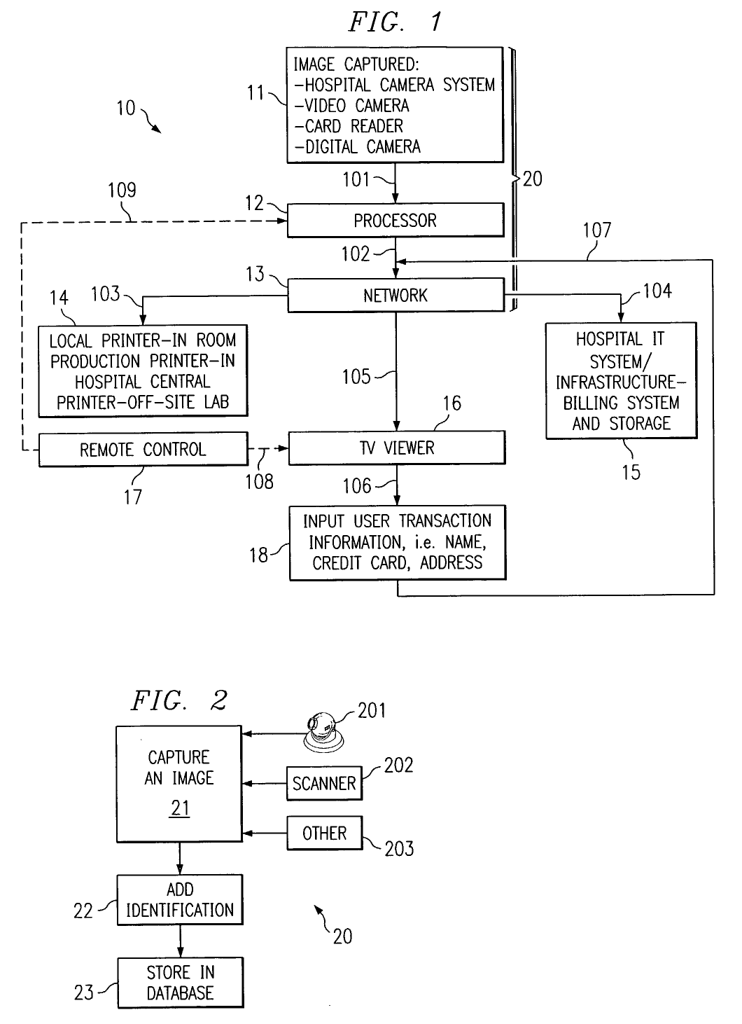

FIG. 2 is a block diagram of one embodiment of a capture method in accordance with the teachings of the invention and shows flow diagram 20 of one embodiment of elements 11, 12, 13 of FIG. 1 where the images are captured via capture device 21, which could be, for example, camera 201, scanner 202, or any other device 203. Identification is added to the captured images via process 22 and the data, including the captured images and identification information, is stored in database under control of process 23.

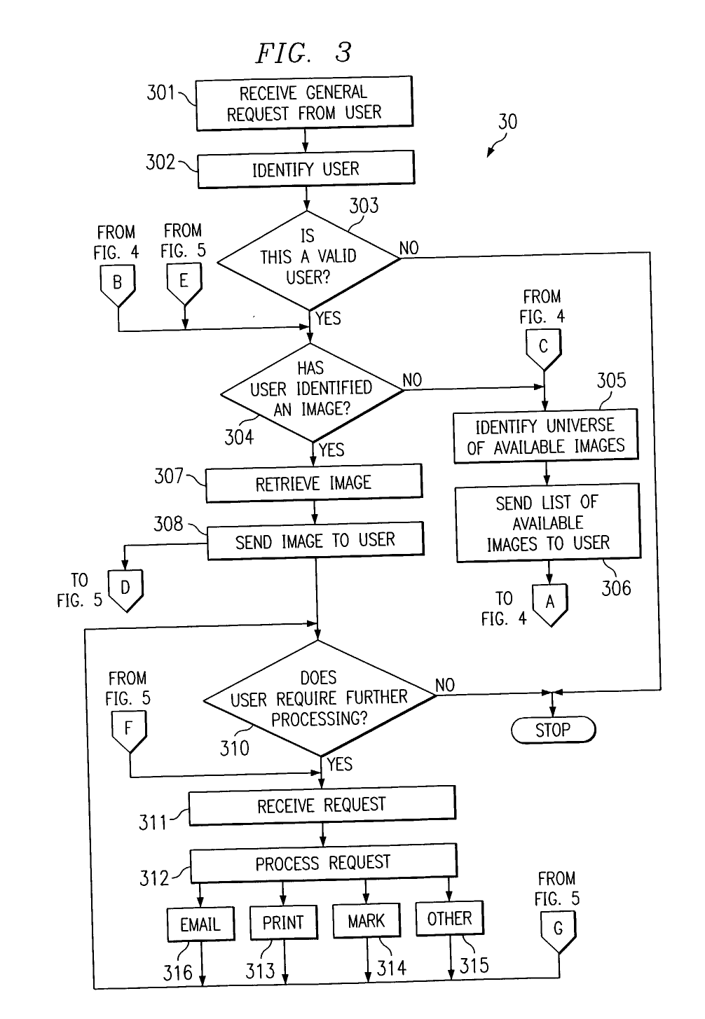

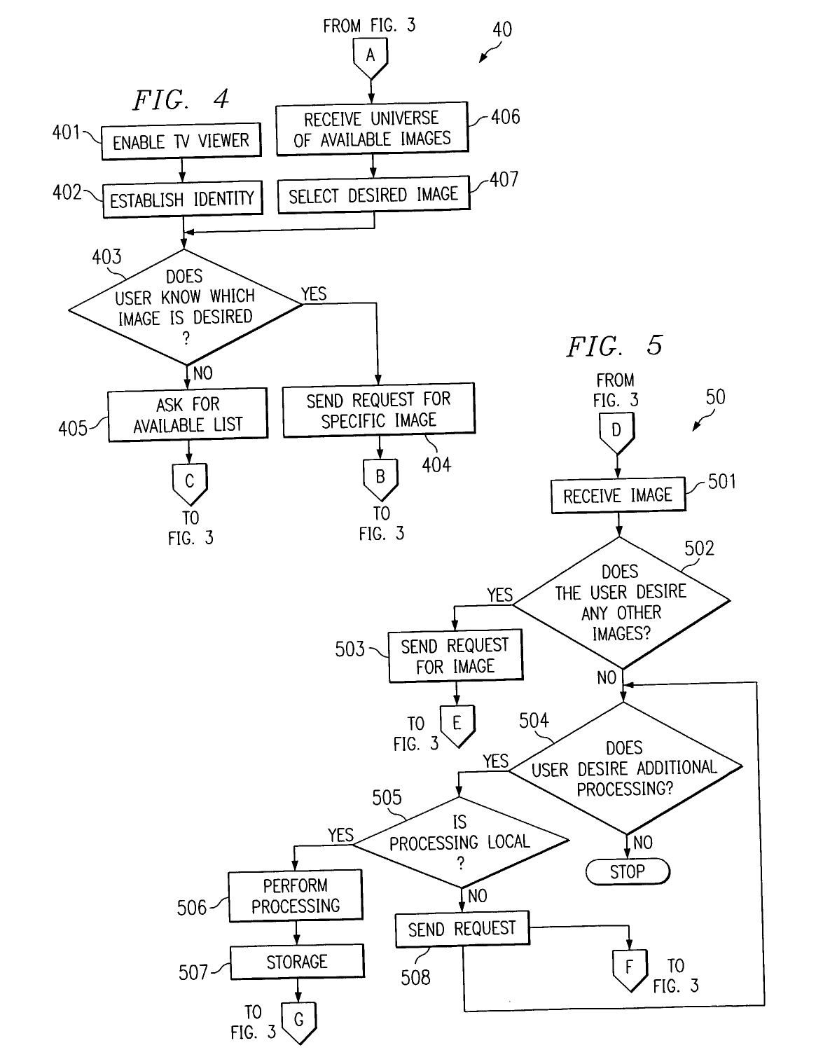

FIG. 3 is a flowchart of one embodiment of a processing method for controlling the requesting of images from a viewer in accordance with the teachings of the invention and shows flowchart 30 which is one embodiment of an operation of a system for receiving requests from a user, processing requests, and presenting images according to the present invention. Flow chart 30 begins at process 301 where general requests are received from a user. Process 302 identifies the user and valid identification is made at process 303, this identification is made by comparing the user to the terminal. If the identification is not valid, processing is stopped. If the identification is valid, then a determination via process 304 is made as to whether the user has identified an image. If not, then the system identifies a universe of available images (those images available to this terminal and this user) via process 305 and, if desired by the user, sends such a list to the user via process 306. Once the user has identified an image, the image is retrieved via process 307 and the image is sent to user via process 308. When the image has been sent, then a check is made at process 310 as to whether the user needs further processing. When the answer is “yes”, then the requests are received via process 311, the requests are processed via process 312, and perhaps the user has identified that a particular image is to be printed (313), marked (314), e-mailed (316), or other operation is to be performed (315). An example of marking could be to keep the image, or other data, for a specific period of time, or for later recovery or transmission. At the completion of process 313, 314, 315, or 316 the system repeats via process 310.

If the answer is “no” at process 310, system 30 stops and waits for a re-initiation of the system by the same or another user.

FIG. 4 is a flowchart of one embodiment of a processing method for controlling the requesting of images from a viewer in accordance with the teachings of the invention and shows flow chart 40, which is typically operating at a TV viewer 16 (FIG. 1) such that the user can follow instructions presented on the screen to obtain an image or other data. This is enabled at process 401 and the identity of the user is established via any one of a number of systems and methods at process 402. These systems and methods could be, for example, by identifying the device, by checking the manual entry of a viewer ID, by validating a fingerprint or other biometric of the user, by using a magnetic stripe or other identifying means or the like. Then a determination is made as to whether a user knows which image is desired via process 403. If “yes”, then a request is sent via process 404 for the specific image, and that request is processed as discussed above with respect to FIG. 3. If the user does not know which image he/she desires, then the user requests available images via process 405. This request is processed as discussed above in FIG. 3. When the universe of available images are received via process 406, the user can select the desired image via process 407. The selected image is processed via process 403 and 404 as discussed above.

FIG. 5 is a flowchart of one embodiment of a processing method for controlling the disposition of selected images in accordance with the teachings of the invention and shows flowchart 50, which is typically operating at viewer 16 (FIG. 1) under control of the user, as discussed above. When an image is received at process 501, the question, “Does the user desire any other images?” is then presented at process 502. If the answer is “yes”, then a request for the other images at process 503 is provided and processed as discussed above. If the user does not desire any other images the question becomes, “Does the user desire additional processing?” at process 504 If the user does not desire additional processing with respect to the images, the process of flowchart 50 stops. If the answer in process 504 is “yes”, then a determination is made as to whether the processing is local at process 505. If the processing is not local then the request is transmitted via process 508 and this continues until all requests are finished. If the processing is local then process 506 performs the processing with respect to the images and process 507 stores the processed images.

What is claimed is:

1. An enterprise system for controlling the delivery of services; said system comprising:
a recorder, said recorder operable for making records of physical objects presented to said recorder, each said record including information pertaining to certain potential users;
a storage medium for retaining records made by said recorder; and
a plurality of terminals dispersed about said enterprise, said terminals operable when temporarily assigned to an individual for allowing the assigned individual to view certain retained records by entering specified information pertaining to the desired records at said assigned terminal, said system only allowing terminals to access records that are available to the individual to whom said terminal is assigned.

2. The system of claim 1 wherein said recorder is a camera.

3. The system of claim 1 wherein said information pertaining to said records includes at least one person other than the person who is the subject of said record.

4. The system of claim 1 wherein said enterprise is a hospital and said users are patients assigned to different rooms within said hospital and said assigned terminal is the TV in said patient's room.

5. The system of claim 4 wherein said system is operable to provide a printed copy of a viewed record upon demand of said patient.

6. The system of claim 5 wherein said system is operable to coordinate said camera images with respect to information pertaining to certain potential viewers, said records including said certain potential viewer information.

7. The system of claim 6 wherein said records comprise images of new-born babies within said hospital and said certain potential viewers are related to said new-born babies.

8. A method of allowing parents to view their children in a hospital setting, said method comprising:
capturing images of said children;
storing said images;
receiving a request from a parent pertaining to images said parent desires to view;
screening said request for proper identification for said desired image; and
providing, under control of said screening process, said desired image to a TV monitor associated with said requesting parent.

9. The method of claim 8 further includes:
sending from said parent signals representing said desired image.

10. The method of claim 9 wherein said sending process is performed at a device remote from said TV monitor.

11. The method of claim 9 wherein said assigned TV monitor is a TV monitor in a hospital room assigned to said parent.

12. The method of claim 8 further including:
accepting from said requesting parent instructions for subsequent processing of said desired image.

13. The method of claim 12 wherein said subsequent processing is the printing of a desired image.

14. A system for providing visual monitoring of selected hospital patients, said system comprising:
a device for capturing images of certain of said patients;
a storage device for storing thereon for periods of time captured ones of said images; and
a processor for
accepting from potential viewers an identification of a desired image to be viewed;
said processor operable for comparing requests from said potential viewers against an identification of allowed viewers for a particular desired image to be viewed, and further operable upon a positive comparison from a particular potential viewer for transmitting said desired image to a terminal pre-assigned to said potential viewer.

15. The system of claim 14 wherein said processor accepts said requests from a device other than said pre-assigned terminal.

16. The system of claim 14 wherein said processor accepts said requests from said pre-assigned terminal.

17. The system of claim 14 further including:
a plurality of terminals positioned in rooms of said hospital and wherein said assignment of a terminal includes assigning said potential viewer to one of said rooms containing said terminal.

18. The system of claim 14 wherein said captured images are frame by frame images.

19. The system of claim 14 wherein said captured images are video images.

20. The system of claim 14 wherein said captured image includes audio.

21. An enterprise system for controlling the delivery of services; said system comprising:
means for making records of physical objects, each said record including information pertaining to certain potential users;
means for retaining any said made records;
communications means dispersed about said enterprise and operable when temporarily assigned to an individual for allowing the assigned individual to view certain retained records by sending specified information pertaining to said certain retained records; and
means for allowing viewing of said certain retained records only from communication means that are assigned to users having access to said certain retained records.

22. The system of claim 21 wherein said record making means comprises a camera.

23. The system of claim 21 wherein said information pertaining to said certain retained records includes at least one person other than the person who is the subject of said record.

24. The system of claim 21 wherein said enterprise is a hospital and said users are patients assigned to different rooms within said hospital and said communication means comprises a TV in said patient's room.

25. The system of claim 24 wherein said system is operable to provide a printed copy of a viewed record upon demand of said patient.

26. The system of claim 25 wherein said system is operable to coordinate said camera images with respect to information pertaining to certain potential viewers, said records including said certain potential viewer information.

27. The system of claim 26 wherein said records comprise images of new-born babies within said hospital and said certain potential viewers are related to said new-born babies.
